(19) United States
(12) Patent Application Publication
(10) Pub. No.: US 2025/0382779 A1
(43) Pub. Date: Dec. 18, 2025

(54) ELECTRONIC FILTER SWITCH

(71) Applicant: Delta Faucet Company, Indianapolis, IN (US)

(72) Inventors: Joshua Drew Wales, Indianapolis, IN (US); Kurt Judson Thomas, Indianapolis, IN (US)

(21) Appl. No.: 18/875,482

(22) PCT Filed: Jun. 20, 2023
(86) PCT No.: PCT/US2023/025747

§ 371 Date: Dec. 16, 2024

Related U.S. Application Data
(60) Provisional application No. 63/353,739, filed on Jun. 20, 2022.

(51) Int. Cl. E03C 1/04; E03C 1/02

(52) U.S. Cl. CPC E03C 1/04; E03C 2001/026; E03C 2201/40

(57) ABSTRACT

A water diverter device for use with a faucet including an electrically operable valve assembly and a control module for controlling the flow of cold water to a water filter.

### CROSS-REFERENCE TO RELATED APPLICATION

The present application claims priority to U.S. Provisional Patent Application Ser. No. 63/353,739, filed Jun. 20, 2022, the disclosure of which is expressly incorporated herein by reference.

### BACKGROUND AND SUMMARY OF THE INVENTION

The present invention relates generally to a water diverter device and, more particularly, to an electronic filter switch for selectively delivering filtered water to a faucet.

It is known to provide various under-sink filtration devices that utilize a dedicated drinking water faucet. Such a dedicated faucet, in addition to a conventional kitchen faucet, may not be desired since it adds visual clutter and/or requires additional holes be cut into the mounting deck (e.g., countertop). As such, many users desire that their traditional kitchen faucet be a source of filtered water. However, such a design may include certain limitations. First, the high flow rate of typical kitchen faucets require very large filters for high quality filtration. Additionally, the large amount of water used by a standard kitchen faucet would likely require frequent filter replacement.

As such, there is a need for a device that could allow a user to select between filtered and unfiltered water at the main or primary kitchen faucet. Additionally, it is desired to provide such a device that prevents unfiltered hot water from being unintentionally mixed with filtered cold water if the user forgot that the faucet handle was in a mixed water position when attempting to dispense filtered water. Generally speaking, drinking water filters are not effective on hot water, are damaged by hot water, and/or release stored toxins when hot water flows therethrough and, as such, under sink water filters are typically installed on a cold water supply line.

According to an illustrative embodiment of the present disclosure, a water diverter device includes an electrically operable valve assembly in fluid communication with a cold water source and a hot water source, a control module electrically coupled to the electrically operable valve assembly, and a filtration system in fluid communication with the electrically operable valve assembly. A user interface is electrically coupled to the control module. An unfiltered cold water path is defined by the electrically operable valve assembly from the cold water source to a water outlet. A filtered cold water path is defined by the electrically operable valve assembly from the cold water source to the water outlet. An unfiltered hot water path is defined by the electrically operable valve assembly from the hot water source to the water outlet. A normal position of the valve assembly allows cold water and hot water to flow to the water outlet via the unfiltered cold water path and the unfiltered hot water path. The control module utilizes input from the user interface to change the position of the valve assembly to a filtered position to stop the flow of cold water and hot water via the unfiltered cold water path and the unfiltered hot water path, and allow only filtered cold water to flow to the water outlet via the filtered cold water path.

According to another illustrative embodiment of the present disclosure, a water diverter device includes an electrically operable valve assembly having a cold water inlet in fluid communication with a cold water source, a hot water inlet in fluid communication with a hot water source, and a filtered water inlet, and a filtration system in fluid communication with the filtered water inlet of the electrically operable valve assembly. The electrically operable valve assembly includes a first mode and a second mode, the cold water inlet and the hot water inlet in fluid communication with a water outlet in the first mode, and the filtered water inlet in fluid communication with the water outlet in the second mode.

According to a further illustrative embodiment of the present disclosure, a water diverter device includes a main electrically operable valve assembly having an inlet and an outlet, and a filter electrically operable valve assembly having an inlet and an outlet, the outlet of the filter electrically operable valve assembly fluidly coupled to the inlet of the main electrically operable valve assembly. A filtration system includes an inlet and an outlet, the inlet of the filtration system being fluidly coupled to a cold water source, and the outlet of the filtration system being fluidly coupled to the inlet of the filter electrically operable valve assembly. A controller is operably coupled to the main electrically operable valve assembly and the filter electrically operable valve assembly. A capacitive sensor is operably coupled to the controller. The controller defines a first mode and a second mode, the main electrically operable valve assembly open and the filter electrically operable valve assembly closed in the first mode, and the main electrically operable valve assembly closed and the filter electrically operable valve assembly open in the second mode.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The foregoing aspects and many of the intended advantages of this invention will become more readily appreciated as the same becomes better understood by reference to the following detailed description of exemplary embodiments when taken in conjunction with the accompanying drawings, wherein:

FIG. 1 is a block diagram of an illustrative water filtration system of the present disclosure;

FIG. 2 is a block diagram of a further illustrative water filtration system of the present disclosure;

FIG. 3 is a block diagram of a further illustrative water filtration system of the present disclosure;

FIG. 4 is a block diagram of a further illustrative water filtration system of the present disclosure;

FIG. 5 is a perspective view of an illustrative rotary diverter valve for use within a water filtration system of the present disclosure;

FIG. 6 is a schematic view representing operation of the illustrative rotary diverter valve of FIG. 5;

FIG. 7 is a block diagram of a further illustrative water filtration system of the present disclosure;

FIG. 8 is a perspective view of an illustrative water diverter device including a rotary diverter valve for use with the water filtration system of FIG. 7;

FIG. 9 is an exploded perspective view of the illustrative water diverter device of FIG. 8;

FIG. 10 is a cross-sectional view of the illustrative water diverter device taken along line 10-10 of FIG. 8, showing the valve in a normal tap water mode;

FIG. 11 is a cross-sectional view of the illustrative water diverter device similar to FIG. 10, showing the valve in a filtered water mode;

FIG. 12 is a detailed cross-sectional view of FIG. 10, showing the magnetic reed pipe switch in an off position;

FIG. 13 is a detailed cross-sectional view of FIG. 11, showing the magnetic reed pipe switch in an on position;

FIG. 14 is a perspective view of an illustrative user interface of the water filtration system of FIG. 7;

FIG. 15 is a flow diagram of illustrative function work logic of the water filtration system of FIG. 7;

FIG. 16 is a block diagram of a further illustrative water filtration system of the present disclosure;

FIG. 17 is a schematic view representing operation of an illustrative linear diverter valve for use within a water filtration system of the present disclosure;

FIG. 18 is a perspective view showing a user interface in the form of a wireless button mounted under a countertop for activation of an illustrative water filtration system of the present disclosure;

FIG. 19 is a perspective view showing a user interface in the form of a wireless button mounted to a faucet for activation of an illustrative water filtration system of the present disclosure;

FIG. 20 is a perspective view showing a user interface in the form of a foot activated wireless button for activation of an illustrative water filtration system of the present disclosure;

FIG. 21 is a perspective view showing a user interface in the form of a wireless button on a switch plate for activation of an illustrative water filtration system of the present disclosure;

FIG. 22 is a perspective view showing a user interface in the form of a wireless button mounted on a counter for activation of an illustrative water filtration system of the present disclosure;

FIG. 23 is a perspective view showing a user interface in the form of a cabinet knob for activation of an illustrative water filtration system of the present disclosure;

FIG. 24 is a perspective view showing a user interface in the form of the utilization of a button on a towel rack for activation of an illustrative water filtration system of the present disclosure;

FIG. 25 is a perspective view showing a user interface in the form of a separate spout for activation of an illustrative water filtration system of the present disclosure;

FIG. 26 is a perspective view showing a user interface in the form of a button installed in a hole on a countertop and inside a cabinet door for activation of an illustrative water filtration system of the present disclosure;

FIG. 27 is a perspective view showing a user interface in the form of a button installed on a toe kick for activation of an illustrative water filtration system of the present disclosure;

FIG. 28 is a perspective view showing a user interface in the form of a button coupled to a hanger for activation of an illustrative water filtration system of the present disclosure;

FIG. 29 is a front perspective view of an illustrative water filtration system of FIG. 1;

FIG. 30 is a rear perspective view of the illustrative water filtration system of FIG. 29;

FIG. 31 is a partially exploded perspective view of the water filtration system of FIG. 30;

FIG. 32 is a partial perspective view of the water filtration system of FIG. 30, showing an illustrative water diverter device; and

FIG. 33 is a cross-sectional view of the illustrative water filtration system taken along line 33-33 of FIG. 31.

Corresponding reference characters indicate corresponding parts throughout the several views. Although the drawings represent exemplary embodiments of the various features and components according to the present disclosure, the drawings are not necessarily to scale and certain features may be exaggerated in order to better illustrate exemplary embodiments of the invention, and such exemplifications are not to be construed as limiting the scope of the invention in any manner.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

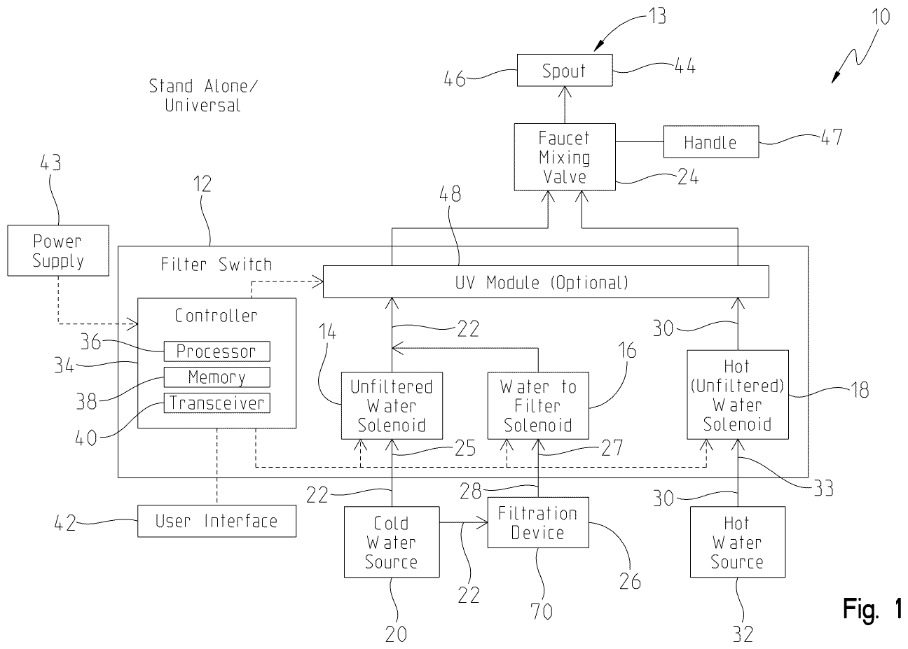

Referring initially to FIG. 1, an illustrative water filtration system 10 of the present disclosure includes a water diverter device 12 for use with a faucet 13 illustratively in fluid communication with, and downstream from, the water diverter device 12. Illustratively, the water diverter device 12 is an electronic filter switch including three electrically operable valves 14, 16, 18 arranged in parallel. In an illustrative embodiment, each electrically operable valve 14, 16, 18 is a solenoid valve although other types of valves may be substituted therefor. The illustrative valve configuration allows for two states or modes of the water filtration system 10. These include a normal or default state or mode (also referred to as a normal tap water mode), and an activated or filtered state or mode (also referred to a filtered water mode).

In the illustrative embodiment, the electrically operable valve 14 (sometimes referred to as an unfiltered water solenoid valve) is a normally open solenoid valve allowing unfiltered cold water 22 from a cold water source 20 to flow through to a faucet mixing valve 24 via an unfiltered cold water path 25. The electrically operable valve 16 (sometimes referred to as a water to filter solenoid valve) is illustratively a normally closed solenoid valve in fluid communication with a water filtration device 26 via a filtered cold water path 27. When the electrically operable valve 16 is open, cold water 22 from the cold water source 20 passes through the filtration system 26 and becomes filtered water 28. However, the electrically operable valve 16 is normally closed, and therefore, does not allow filtered cold water 28 to pass through to the faucet mixing valve 24 in a default condition.

The electrically operable valve 18 (sometimes referred to as a hot (unfiltered) water solenoid valve) is illustratively a normally open solenoid valve and allows hot water 30 from a hot water source 32 to pass through to the faucet mixing valve 24 via an unfiltered hot water path 33. Hence, in the normal or default mode of the system 10, both cold water 22 and hot water 30 flow through the system 10 to the faucet mixing valve 24 via the unfiltered cold water path 25 and the unfiltered hot water path 33, respectively.

In the activated or filtered mode, a control module or controller 34 electrically activates the valves 14, 16, 18. When activated, the electrically operable valve 14 is closed thereby shutting off the unfiltered cold water 22 flowing through the water diverter device 12. Additionally, when activated, the electrically operable valve 16 is opened thereby allowing filtered water 28 to flow through the water diverter device 12 to the faucet mixing valve 24. Finally, when activated, the electrically operable valve 18 shuts off the hot water 30 flowing into the water diverter device 12. Hence, in the activated or filtered mode of the water filtration system 10, hot water 30 is shut off and only filtered cold water 28 passes through the water diverter device 12 to the faucet mixing valve 24.

The control module 34 illustratively includes control electronics (e.g., a processor 36 in communication with a memory 38 storing machine readable instructions for execution by the processor 36) and communication electronics (e.g., radio frequency (RF), Bluetooth and/or Wi-Fi transceiver 40). As such, the control module 34 may be in wired or wireless communication with the electrically operable valves 14, 16, 18 and a user interface 42. The control module 34 and/or the user interface 42 may also include visual indicators (e.g., lights) and/or audible indicators (e.g., buzzers) to provide feedback to the user of system operation. Illustratively, a conventional power supply 43 (e.g., an AC-to-CD converter, and/or batteries) is electrically coupled to the controller 34.

The cold water source 20 may comprise a conventional cold water stop valve, and the hot water source 32 may comprise a conventional hot water stop valve. The mixing valve 24 is illustratively part of the faucet 13 including a delivery spout 44 defining a faucet water outlet 46. The mixing valve 24 may be of conventional design as including a moveable valve member (not shown) operably coupled to a manual valve handle 47 to control the flow of cold water and hot water to an outlet port (not shown), thereby controlling the flow rate and/or the temperature of water supplied to the faucet water outlet 46. The mixing valve 24 may be of the type further detailed in U.S. Pat. No. 7,753,074 to Rosko et al., the disclosure of which is expressly incorporated herein by reference.

The water filtration device 26 may include a water filter 70 of conventional design, such as a 3 stage water filter. An illustrative water filter 70 may be an Aqua-Pure™ water filter available from The 3M Company of Maplewood, Minnesota (USA).

An optional ultraviolet (UV) module 48 may be added to the system 10 and positioned inside the water diverter device 12, and fluidly coupled downstream of all three electrically operable valves 14, 16, 18. The illustrative UV module 48 includes a UV sterilizer (light source) that operates when water is flowing through the system 10. This ensures all of the water is sterilized before it flows into the faucet mixing valve 24 and addresses concerns that users might have regarding filtered water flowing through the same spout 44 as unfiltered water. In certain illustrative embodiments, the UV module 48 may operate sometimes when water is not flowing to ensure the stationary water and the associated flow path remain clean.

The illustrative water filtration system 10 may operate by the user turning on the water at the faucet mixing valve 24 via operation of the handle 47, and then activating the water diverter device 12 via the user interface 42. The user may then visually identify that the water diverter device 12 was activated and operating in the filtered mode by a lower flow rate at the faucet water outlet 46 and/or visual or auditory feedback from the water diverter device 12 (e.g., via the control module 34 and/or the user interface 42). The user may then proceed to use the filtered water defined at the faucet water outlet 46. The water lines required to supply the filtered water are illustratively small and thus, the time to flush them would be nominal (e.g., a few seconds). Shortly after the user notices the water is switched (e.g, modes switched), the lines will be purged.

In an illustrative embodiment, the water diverter device 12 may include a means to display the purge delay to the user. For example, the water diverter device 12 may include a light displaying a progressive color change or a speaker emitting an auditory beep to notify the user that the water filtration system 10 is purged and ready to dispense water. In one illustrative embodiment, the water diverter device 12 may include a light that displays blue when the water is clean (i.e., purge is complete). Illustratively, the water diverter device 12 may include settings for a user to adjust purge time based on flow rate and/or include an advanced device purge based on measured flow rate.

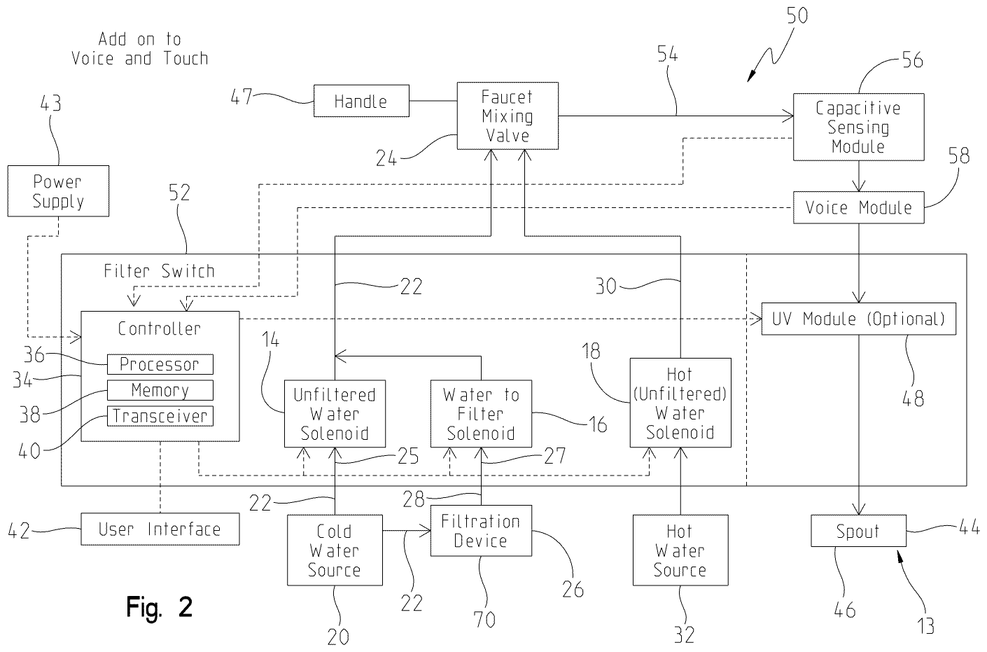

With reference now to FIG. 2, a further illustrative embodiment of the water filtration system 50 is shown. Water filtration system 50 works similarly to water filtration system 10 but is configured as an add-on to existing faucets with electronic control and communication electronics. As such, in the following description, similar components are identified with like reference numbers.

Unfiltered and filtered cold water and unfiltered hot water are provided to the faucet mixing valve 24 in the same manner described above for system 10. However, after exiting faucet mixing valve 24, the mixed water stream 54 illustratively passes through a capacitive sensing or touch control module 56 and/or a voice recognition module 58.

The illustrative capacitive sensing control module 56 includes capacitive sensing technology to detect when a user's hand is near or is touching the faucet 13, such as the delivery spout 44. More particularly, the capacitive sensing control module 56 illustratively includes a capacitive sensor operably coupled to the faucet 13. Once the signal from the capacitive sensor reaches an activation or deactivation threshold, the touch control module 56 communicates the command via digital communication to the controller 34. The controller 34 then dispenses or stops the flow of water based on the command received.

The illustrative voice recognition module 58 includes methods to receive audible input (e.g., voice command) by a user for controlling operation of water flow in the system 50. Voice recognition module 58 is in electrical communication with the controller 34. The controller 34 then controls the flow of water based on communication received from the voice recognition module 58. Illustrative touch control and voice recognition modules may be of the type further detailed in U.S. Pat. Nos. 7,537,023, 7,690,395, 7,150,293, 7,997,301, US Patent Application Publication No. 2020/0299941, and PCT International Patent Application Publication No. WO2009/075858, the disclosures of which are expressly incorporated herein by reference.

Similar to the water diverter device 12, the water diverter device 52 may contain an optional UV module 48. The method and use of operation is the same as previously described. However, in the water diverter device 52, the UV module 48 is illustratively downstream of the faucet mixing valve 24, the touch module 56, and the voice recognition module 58. The UV module 48 is illustratively positioned within the water diverter device 52 just prior to the water outlet 46 of the spout 44.

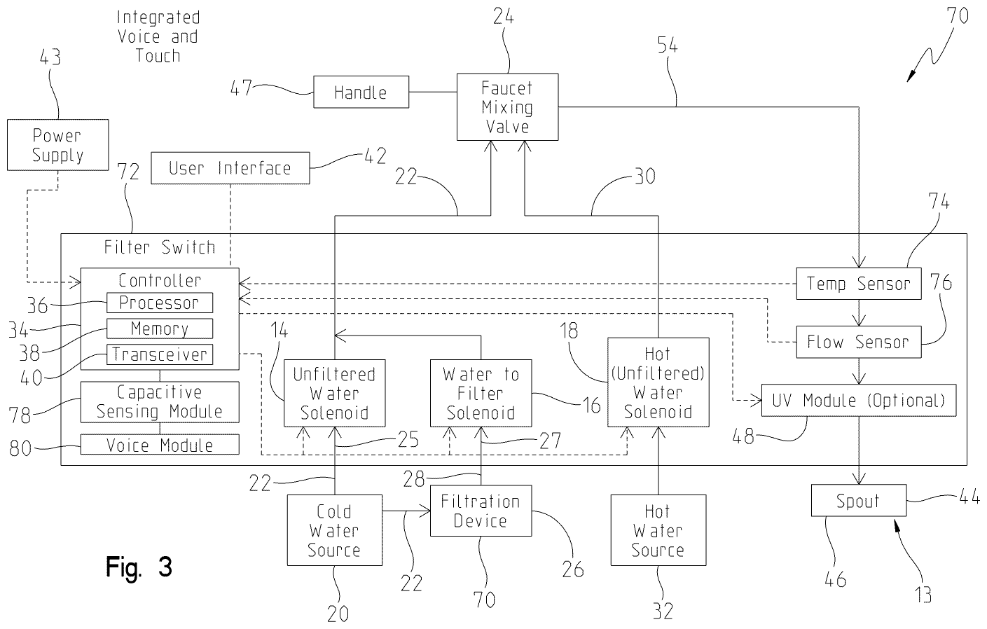

With reference now to FIG. 3, a further illustrative embodiment of the water filtration device 70 is shown. An illustrative advantage of the water filtration system 70 is integrated voice and/or touch sensing such that filtration can be requested by voice and/or touch command, and specific volumes of filtered water could be requested, potentially including purging the water lines, then waiting, then dispensing filtered water, etc. More particularly, the water filtration system 70 works similarly to water filtration system 10 with the incorporation of voice recognition and touch sensing into the water diverter device 72. This is in contrast to the water diverter device 52, which illustratively relies on the touch sensing module 56 and the voice recognition module 58 to be incorporated as part of the existing faucet 13.

As shown in FIG. 3, unfiltered and filtered cold water 22 and 28, and unfiltered hot water 30 are provided to the faucet mixing valve 24 in the same manner described above for the water filtration system 10 of FIG. 1. However, after exiting faucet mixing valve 24, the water stream 54 flows back into the water diverter device 72 and through a temperature sensor 74 and a flow rate sensor 76 before exiting through the spout 44. The temperature sensor 74 and the flow rate sensor 76 provide signals indicative of the temperature and the flow rate, respectively, of the water stream 54 to the controller 34.

The water diverter device 72 illustratively includes a capacitive sensing module 78 (e.g., a capacitive sensor (sensing chip on a printed circuit board (pcb)), which is similar in operation and use to the capacitive sensing module 56 described above. Additionally, the water diverter device 72 illustratively includes a voice recognition module 80 (illustratively, including a Wi-Fi chip) which is similar in operation and use to the voice recognition module 58 described above. Similar to the water diverter device 52, the water diverter device 72 may contain an optional UV module 48, which is positioned within the water diverter device 72 intermediate the mixing valve 24 and the outlet 46 of the spout 44.

In further illustrative embodiments, an electrically operable mixing valve (such as an electrical proportioning valve (EPV)) may be provided upstream from the water diverter device 12, 52, 72 whereby the respective hot water solenoid valve 18 would not be required. This illustrative embodiment would not need an additional shut off valve (i.e., hot water solenoid valve 18) because the EPV would know when to shut off the hot water. More particularly, the upstream EPV may cooperate with the control module 34 to ensure that hot water is off before the water diverter device 12, 52, 72 activates to allow water flow through the respective filtration device 26. The water diverter device 12, 52, 72 can be downstream from the EPV because the EPV could ensure the supplied water is always cold before the water diverter device 12, 52, 72 is activated.

The illustrative water filtration system 10 of FIG. 1 is configured to be a fully standalone universal device that may be used with most conventional kitchen faucets. The illustrative water filtration system 50 of FIG. 2 is configured to provide for potential communication with the filter switch device 52 to activate it using touch commands or voice commands and not requiring a separate remote button. In this scenario, the touch or capacitive sensing module is an entire touch product which includes an electrically operable valve and/or a temperature sensor.

In the water filtration system 70 of FIG. 3, the capacitive sensing module 78, the voice recognition module 80, and the water diverter device 72 are fully integrated. So in addition to not requiring a separate button because the water diverter device 72 can be activated using touch or voice, it has the added advantage of not needing a redundant solenoid in the capacitive sensing module 78 because the water diverter device 72 can turn the water on and off using the filter switch valves 14, 16, 18. The water filtration system 70 also provides the ability to use meter dispense of the filtered water with the voice module 80.

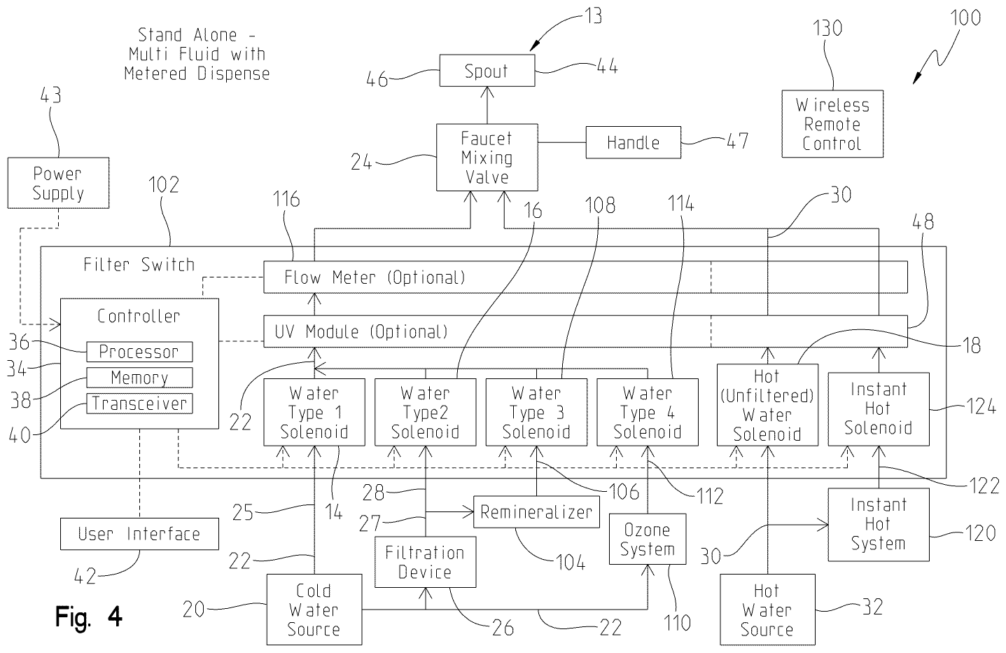

With reference now to FIG. 4, another illustrative embodiment of the water filtration system 100 is shown as including a water diverter device 102. The water diverter device 102 illustratively includes a plurality of electrically operable valves 14, 16, 108 and 114 arranged in parallel to each other and configured to control the flow of different types of water to the water outlet 46. As further detailed in connection with the illustrative embodiment, the electrically operable valve 14 (sometimes referred to as an unfiltered water solenoid valve) is a normally open solenoid valve allowing unfiltered cold water 22 from the cold water source 20 to flow through to the faucet mixing valve 24 via the unfiltered cold water path 25. The electrically operable valve 16 (sometimes referred to as a water to filter solenoid valve) is illustratively a normally closed solenoid valve in fluid communication with the water filtration device 26 via a filtered cold water path 27.

The electrically operable valve 108 (sometimes referred to as a supplemental cold water valve or remineralizer solenoid valve) is a normally closed solenoid valve in fluid communication with the filtration device 26 and a remineralizer 104 via a remineralizer flow path 106. The electrically operable valve 114 (sometimes referred to as a supplemental cold water valve or ozone solenoid valve) is a normally closed solenoid valve in fluid communication with an ozone system 110 via an ozone flow path 112.

In the default mode of operation, the water diverter device 102 works similarly to the water diverter device 12 described above. In the activated mode, the water diverter device 102 is capable of switching through multiple forms of modified water. Cold water 22 may pass through the filtration device 26. The filtered cold water 28 then may either go directly to the faucet mixing valve 24 by opening the electrically operable valve 16 or it may pass through a remineralizer system 104.

The illustrative remineralizer system 104 may be of conventional design and adds minerals back to the water following filtration. The remineralized water 106 then flows to the faucet mixing valve 24 by opening the electrically operable valve 108. Additionally, cold water 22 from the cold water source 20 can flow directly into an ozone system 110 to reduce contaminants in the water. In other illustrative embodiments, the ozone system 110 may be positioned to receive filtered water from the filtration device 26.

With further reference to the illustrative embodiment of FIG. 4, the ozonated water 112 flows to the faucet mixing valve 24 by opening the electrically operable valve 114. The ozone system 110 may be of conventional design for treating water via an ozone generator. Exemplary ozone generators may be available from EOI Electrolytic Ozone Inc. or Klaris Corporation Inc. Additional details of ozone generator systems are detailed, for example, in U.S. Pat. No. 9,919,939 to Rosko et al., the disclosure of which is expressly incorporated herein by reference. Remineralized and ozonated water are illustratively shown in FIG. 4, but other types of modified water could be substituted therefor. For example, water with different mineral blends, flavored water, and/or carbonated water could be substituted therefor.

Similar to the water diverter device 12, the water diverter device 102 may contain an optional UV module 48. The method and use of operation is similar to that previously described. Additionally, the water diverter device 102 may contain a flow meter 116 to measure the flow of water passing through the system 100 and provide a signal indicative thereof to the controller 34. The use of the flow meter 116 in the system 100 has the added benefit of the water filtration system 100 being able to track filter life, particularly if the filter system 26 used has a known filter life. A smart application or button on the water diverter device 102 and/or the user interface 42 could be used to configure filter life of the attached filtration system 26, and could even track multiple filter stages with different filter lives based on actual usage. Filter life tracking could be possible without the use of the flow meter 116. The user could either measure the flow or use a value from a product data sheet and then measure the time the filter system 26 is active. This would still provide more accurate life tracking than estimating usage based on time which is what most users normally do.

If coordinated with the filter or filter life tracking based on flow notifications, automatic ordering of replacement filters could be accomplished through a smart application (for example, via a smart phone). Reduced flow rate could be diagnosed over time indicating filter plugging. All of this could be accomplished when linked to the controller 34 and/or an external processing unit. High water temperature could be flagged by a touch module or voice recognition device as an indication of the water diverter device hot water shut off failure. Feedback could also be given to the user that they forgot to turn the water to cold and/or notice the flow rate is abnormally low and ask the user if they have the handle on full flow, full cold. Additionally, the system 100 could be configured to track ozone system 110 maintenance.

Other benefits of adding a flow meter 116 to the system 100 include the possibility of a metered dispense. Since the water diverter device 102 can turn the water on and off (both hot and cold separately), purge lines, indicate state, etc., it could also perform metered dispensing of filtered water, hot water, or the other water types. Additionally, integration of an ozone system 110 could be used as a sterilizing method for the water diverter device 100 and faucet 13, even for just a brief period of time prior to filtered water use.

The control module 34 may include a routine of computer executable instructions stored in the memory 38 for execution by the processor 36 for operation of the water filtration system 100, including the purging the water lines and then allowing the user to activate (e.g., via a touch of the faucet 13) a metered dispense of filtered water. Flow notifications and/or automatic ordering of replacement filters could be accomplished via input from metered dispense operation of the water diverter device 102 and/or from the flow meter 116. Furthermore, reduced flow rate could be diagnosed over time indicating filter plugging. Also, high water temperature could be flagged by the control module 34 as an indication of operational failure of the hot water electrically operable valve 18. Feedback could also be provided that the user failed to turn on the cold water and/or notice that the flow rate is abnormally low, and ask the user if the handle 47 of the mixing valve 24 is in a full cold water position.

Additionally, the illustrative water diverter device 102 may include a conventional instant hot water system 120. Hot water 30 from hot water source 32 may flow through the instant hot water system 120. The hot water 122 then flows to the faucet mixing valve 24 by opening an electrically operable valve 124. The illustrative system 100 may include a wireless remote control 130 that allows a user to input the requested water type. The wireless remote control 130 is in communication with the controller 34. The controller 34 then configures the system 100 by opening and closing the electrically operable valves 14, 16, 18, 106, 112 and 124 to output the requested water type of the user. The wireless remote control 130 may form part of the user interface 42, or be separate and distinct therefrom.

In some illustrative embodiments, the system 100 may also include a method to indicate to the user that the water is clean (or in the case of something other than filtered water, that the water type has successfully changed). The wireless remote control 130 and/or the user interface 42 could contain lights that change in color, brightness, or blink to indicate the change in status to the user. The lights could show a user that the water diverter device 102 is activated, when the water type has switched, and when the water has had time to purge out the lines and is ready to drink. In one illustrative embodiment, auditory or verbal queues could be used to notify the user of changes in the system 100. In another illustrative embodiment, a water pulse could be used to notify the user of changes in the system 100. When the water is changed to a new water type, the water flows until all the water has flushed out of the lines, the water flow stops momentarily, and then starts again, signifying the change to the user.

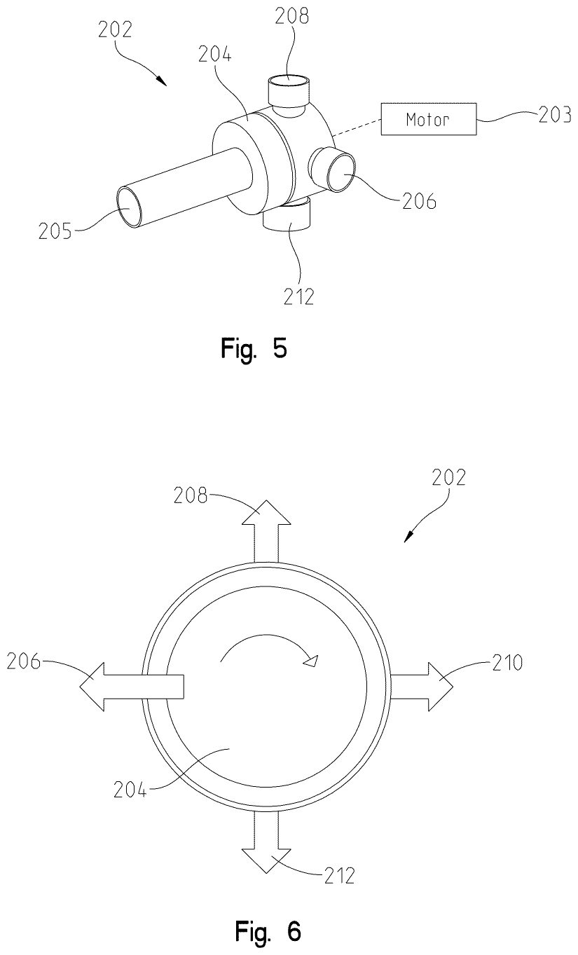

With reference to FIGS. 5 and 6, a further illustrative embodiment water diverter device 200 includes a rotary or rotational diverter valve 202 in place of multiple solenoid valves 14, 16, 18, 106, 112 and 124 as described in FIGS. 1-4. The valve 202 is combined with a gear motor 203 or other rotational actuator. A three function diverter valve, such as Model T11843 available from Delta Faucet Company of Indianapolis, Indiana could be used. The rotor 204 is configured to receive water via an inlet 205 and as the rotor 204 rotates, the water connects to different outlets 206, 208, 210, 212. Illustratively, four outlets are shown, but the valve 202 could include any number of outlets and/or inlets. Additionally, the valve 202 could include multiple simultaneous outlets, i.e. water could flow from any combination of the outlets 206, 208, 210, 212.

In the illustrative water diverter device 200, the outlets 206, 208, 210, 212 and the inlet 205 are reversed, such that the outlets 206, 208, 210, 212 receive water to define inlets, and the inlet 205 discharges water to define an outlet. A double version of such a rotational diverter valve 202 could be used to redirect cold water and shut off the hot water at the same time. Such a rotational diverter has little to no bias or water pressure that resists rotation, which makes it easy to rotate with a small, inexpensive gear motor 203.

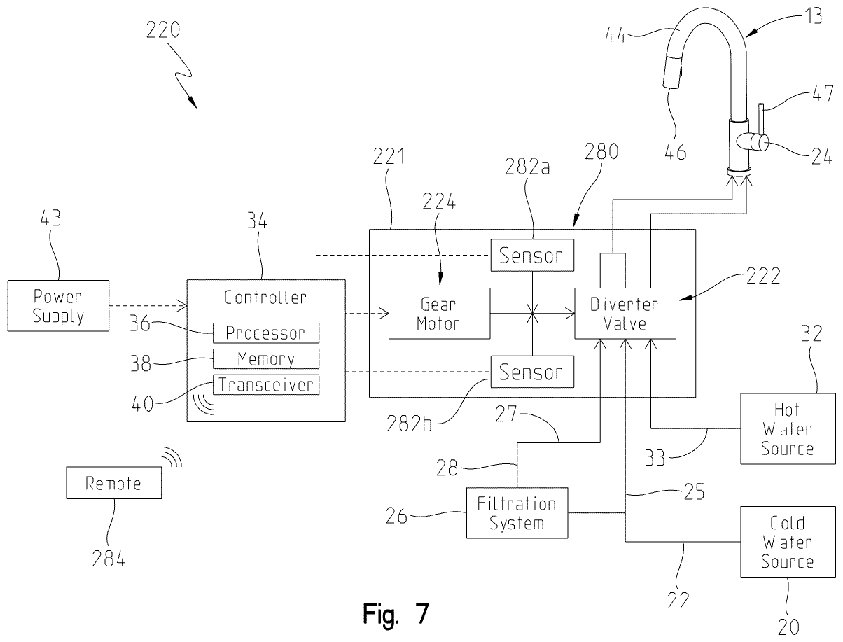

FIGS. 7-14 show a further illustrative water filtration system 220 including a water diverter device 221 in the form of a double rotary or rotational diverter valve 222. The illustrative water filtration system 220 includes many similar features to those detailed above in connection with other illustrative water filtration systems 10, 50, 70, 100. As such, in the following description, similar components are identified with like reference numbers.

The illustrative diverter valve 222 is operably coupled to a rotational actuator, such as a gear motor 224 which, in turn, is operably coupled to the controller 34. With further reference to FIG. 7, the water filtration system 220 is illustratively in fluid communication with the cold water source 20 and the hot water source 32. The cold water source 20 is configured to supply cold water 22 to an unfiltered cold water path 25 and a filtered cold water path 27. A filtration system 26 is illustratively provided in the filtered cold water path 27 to supply filtered cold water 28 to the water diverter device 221. The hot water source 32 illustratively provides hot water to the water diverter device 221 via an unfiltered hot water path 33.

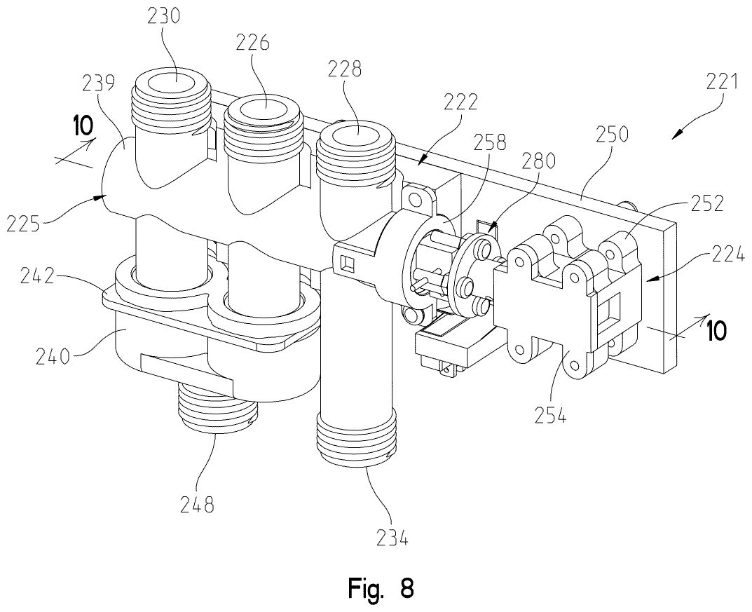

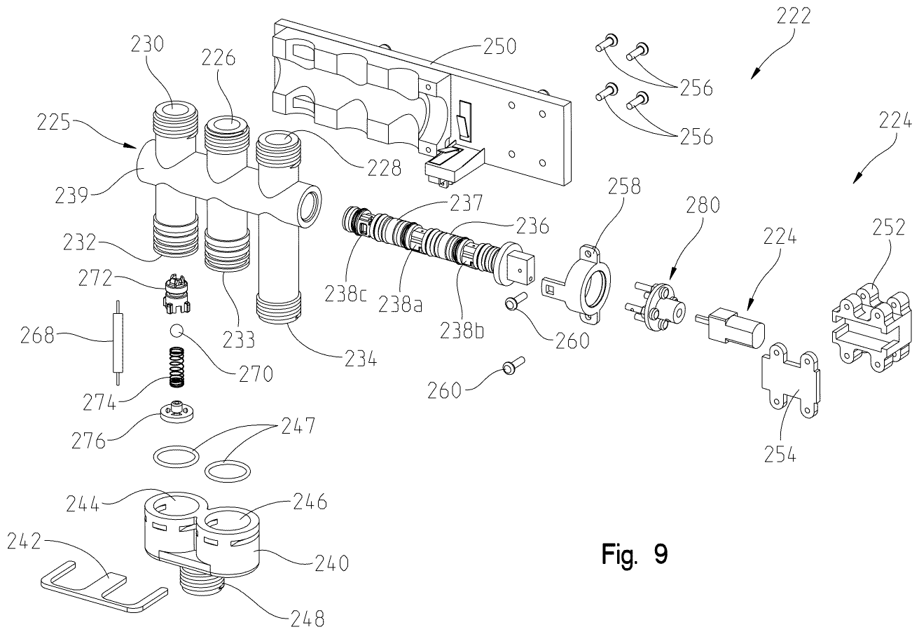

Referring now to FIGS. 8 and 9, the diverter valve 222 illustratively includes a valve body 225 including an unfiltered cold water inlet 226 in fluid communication with the unfiltered cold water path 25, a hot water inlet 228 in fluid communication with the unfiltered hot water path 33, and a filter water inlet 230 in fluid communication with the filtered cold water path 27. With reference to FIG. 9, the illustrative valve body 225 further includes a filter water outlet 232 in fluid communication with a mixing valve 24 of the faucet 13, an unfiltered cold water outlet 233 in fluid communication with the faucet mixing valve 24, and a hot water outlet 234 in fluid communication with the faucet mixing valve 24.

The illustrative diverter valve 222 includes a rotary valve member 236 for controlling fluid communication between the water inlets 226, 228, 230 and the water outlets 232, 233, 234. The rotary valve member 236 illustratively includes a rotatable rod or piston 237 including a plurality of axially spaced apart control recesses 238a, 238b and 238c. The control recesses 238a, 238b and 238c are illustratively associated with the unfiltered cold water inlet 226, the hot water inlet 228 and the filter water inlet 230, respectively.

The valve body 225 illustratively includes a main body portion 239 fluidly coupled to a connector portion 240. A clip 242 illustratively secures the connector portion 240 to the main body portion 239. The connector portion 240 includes a first inlet 244 and a second inlet 246 in fluid communication with a combined outlet 248. The first inlet 244 is fluidly coupled to the filter water outlet 232, and the second inlet 246 is fluidly coupled to the unfiltered cold water outlet 233. O-rings 247 are illustratively received within the inlets 244 and 246 to provide a fluid seal between the connector portion 240 and the main body portion 239 of the valve body 225.

Illustratively, the diverter valve 222 also includes a support bracket 250 supporting the valve body 225 and the motor 224. A mount 252 couples the motor 224 to the support bracket 250, and a cover 254 is secured to the mount 252. Conventional fasteners, such as bolts 256, illustratively secure the mount 252 to the support bracket 250. A valve support 258 receives the rotary valve member 236, and couples the valve body 225 to the support bracket 250. Conventional fasteners, such as bolts 260, illustratively secure the valve support 258 to the support bracket 250.

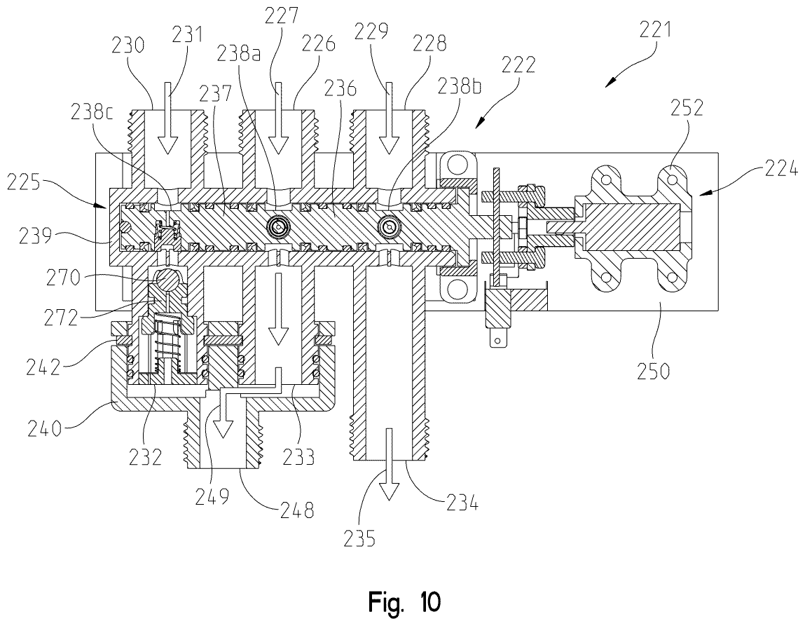

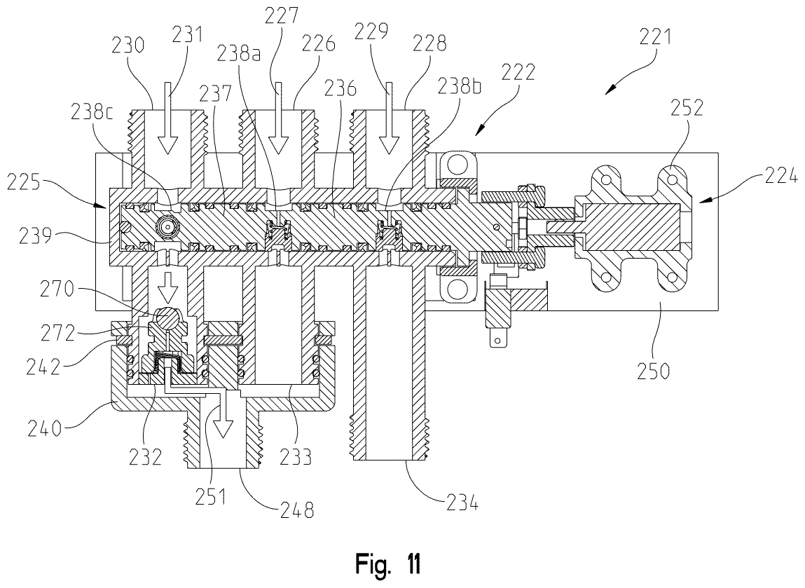

With further reference to FIG. 10, the rotary valve member 236 of the rotational diverter valve 222 in the default or normal tap water mode provides for normal operation of the faucet 13 via the mixing valve 24. More particularly, the cold water inlet 226 is in fluid communication with the cold water outlet 233 via the control recess 238a, and the hot water inlet 228 is in fluid communication with the hot water outlet 234 via the control recess 238b. As such, cold water 227 may flow through the cold water inlet 226 past the control recess 238a. Cold water 249 then passes through the cold water outlet 233 and exits the valve body 225 via the combined outlet 248. Similarly, hot water 229 may flow though the hot water inlet 228 past the control recess 238b. Hot water 235 then exits the valve body 225 via the hot water outlet 234. Simultaneously, the diverter valve 222 blocks cold water 231 from flowing through the filter water outlet 232, as further detailed herein.

FIG. 11 shows the rotational diverter valve 222 in the activated or filter water mode where the rotary valve member 236 has been rotated by the motor 224 from the position of FIG. 10. In this mode, the rotary valve member 236 blocks cold water 227 from flowing from the cold water inlet 226 to the cold water outlet 233. The rotary valve member 236 also blocks hot water 229 from flowing from the hot water inlet 228 to the hot water outlet 234. Simultaneously, the rotary valve member 236 provides fluid communication between the filter water inlet 230 and the filter water outlet 232 via the control recess 238c. The rotary valve member 236 is illustratively moved using a single motor 224, similar to that detailed above in connection with the diverter valve 202.

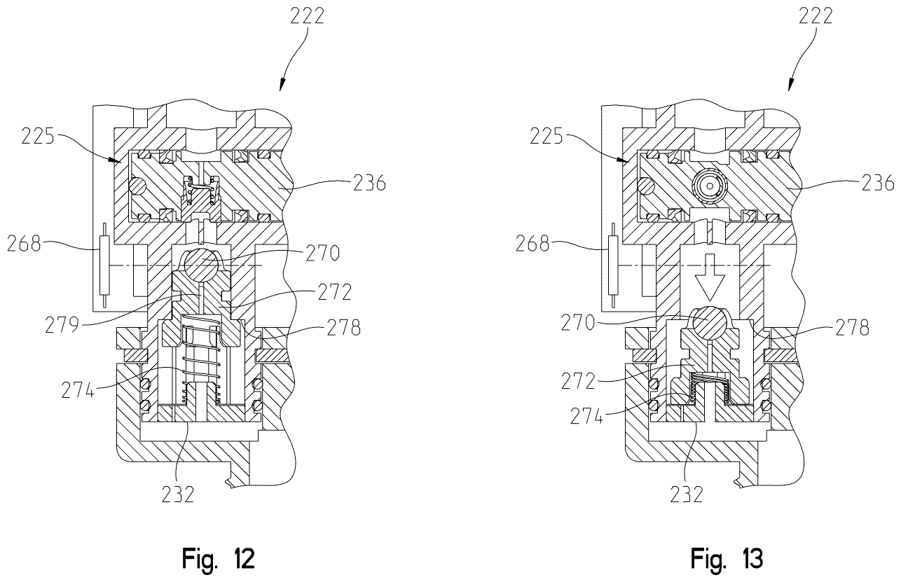

As shown in FIGS. 12 and 13, a magnet reed pipe switch 268 may be provided to selectively block water flow through the filter water outlet 232. Illustratively, the switch 268 is operably coupled to a magnet 270 supported by a blocking piston 272, wherein a spring 274 is operably coupled to the piston 272. The spring 274 is positioned between a base 276 and the piston 272.

The piston 272 is configured to move between a blocked position (i.e., filter water off) where it engages with the valve seat 278 (FIGS. 10 and 12), and an unblocked position (i.e., filter water on) where it is in spaced relation to a valve seat 278 (FIGS. 11 and 13). In the blocked position, the illustrative piston 272 blocks most of the water flow through the filter water outlet 232. More particularly, cold water 231 at the filter water inlet 230 is restricted from flowing to the filter water outlet 232 and combined water outlet 248. However, an intentional leak path 279 may be provided through the center of the piston 272 such that limited water flow occurs in the filter water off mode of FIGS. 10 and 12.

In the unblocked position, the illustrative piston 272 is spaced from the valve seat 278 allowing cold water 231 to flow through the filter water outlet 232 and out the combined water outlet 248 (with the cold water shown by arrow 251 in FIG. 11). The reed switch 268, and the piston 272 supporting the magnet 270 received within the filter water outlet 232, may define a relatively inexpensive flow switch similar to that noted above in connection with the illustrative water filtration system 10.

In an illustrative embodiment, a sensor assembly 280 is operably coupled to the gear motor 224. More particularly, the sensor assembly 280 illustratively includes sensors 280a, 280b operably coupled to the controller 34 to detect the relative rotational position of the rotary valve member 236. The sensors 282a, 282b are illustratively switches to detect the relative position of the rod 237. The sensors 282a, 282b are configured to confirm the mode or state of the rotary diverter valve 222, such that the user has confidence that he/she is receiving filtered water (i.e., filtered water is flowing through the filter outlet 232). If the sensors 282a, 282b do not confirm the diverter valve 222 switched states correctly (e.g., from the normal tap water mode of FIG. 10 to the filter water mode of FIG. 11), an indicator (e.g., LED light) in a remote user interface 284 may indicate to him/her that the discharged water is not filtered.

FIG. 12 is a detailed cross-sectional view of FIG. 10, showing the magnetic reed pipe switch 268 in a filter water on position. FIG. 13 is a detailed cross-sectional view of FIG. 11, showing the magnetic reed pipe switch 268 in a filter water off position. As detailed above, the piston 242 is configured to move between a blocked position (i.e., filter water off) where it engages with the valve seat 243 (FIG. 12), and an unblocked position (i.e., filter water on) where it is in spaced relation to a valve seat 243 (FIG. 13).

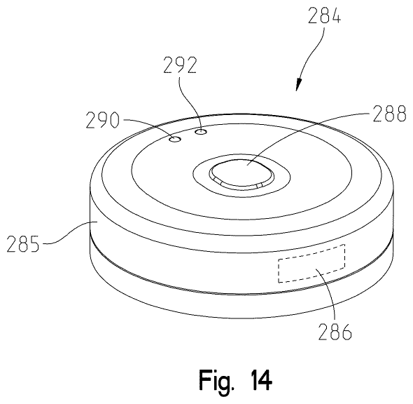

FIG. 14 shows an illustrative user interface 284 of the water filtration system 220 including a puck housing 285 receiving a wireless transmitter 286. An activation button 288 (e.g., a push button) and first and second visual indicators 290 and 292 (e.g., lights, such as light emitting diodes) are supported by the housing 285. Illustratively, the visual indicator 290 is a first color light (e.g., a red light emitting diode), and the visual indicator 292 is a second color light (e.g., a blue light emitting diode).

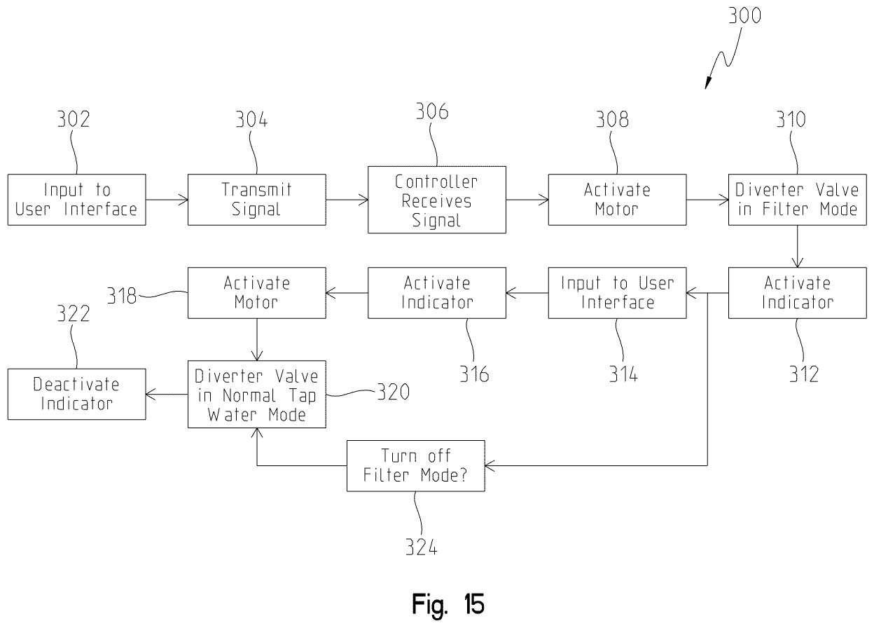

FIG. 15 is a flow diagram of illustrative function work logic of the water filtration system 220 of FIG. 13. It should be noted that the electronics of the water filtration system 220 of FIG. 13 and related functions of FIG. 15 could be replaced with other suitable electronics to provide desired functionality, for example, logic controlling how the lights 290, 292 signal the filtered and unfiltered states based on valve position and/or delay time.

The illustrative process 300 of FIG. 15 begins at block 302 where a user provides input to the user interface 284 by depressing the button 288. Upon depressing the button 288, the process continues to block 304 where the transmitter 286 of the user interface 284 transmits a wireless signal. At this time, the red light emitting diode 290 illustratively flashes to provide an indication of wireless transmission to the user. At block 306, the transceiver 40 of the controller 34 receives the wireless signal. In response, the controller 34 activates the motor 224 at block 308. At block 310, the diverter valve 222 is in an active or filter water mode where filtered water is provided to the water outlet 46. The controller 34 then sends a signal to the user interface 284 which, in response, activates the blue light emitting diode 292 at block 312. More particularly, the blue light emitting diode 292 provides steady illumination.

With further reference to FIG. 15, additional input may be provided at block 314 by the user depressing the button 288. At block 316, the red indicator light 290 on the user interface 284 illustratively flashes to provide an indication of wireless transmission to the user. At block 318, the motor 224 is activated to place the diverter valve 222 in the normal tap water mode as indicated at block 320. At block 322, the controller 34 then sends a signal to the user interface 284 to deactivate the indicators 290, 292. At block 324, if a user forgets to turn the water filtration system 220 from the filter water mode to the tap water mode after a predetermined time, the motor 224 will automatically move the diverter valve 222 back to the normal tap water mode at block 320.

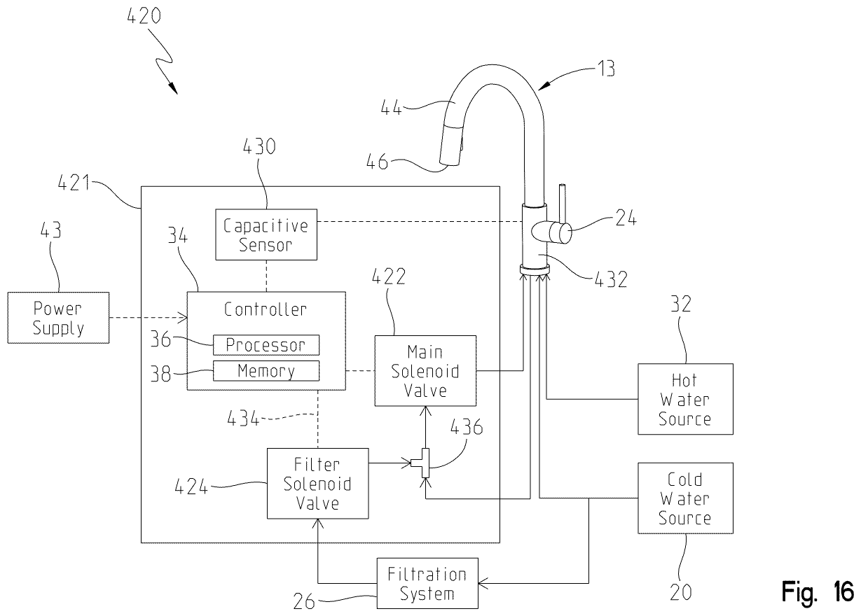

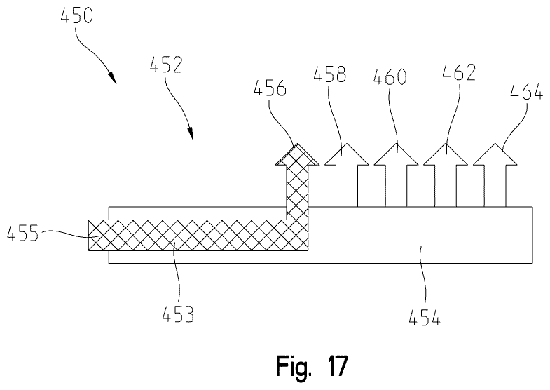

FIG. 16 illustrates a further water filtration system 420 including many similar components as the above-identified water filtration systems 10, 50, 70, 100, 220. As such, in the following description, similar components are identified with like reference numbers.

The illustrative water filtration system 420 includes a water diverter device 421 having a first or main electrically operable valve 422, and a second or filter electrically operable valve 424. Illustratively, the electrically operable valves 422 and 424 are solenoid valves. A power supply 43 (e.g., a battery) may provide power to the system 420 via the main solenoid valve 422 operably coupled to controller 34. The controller 34 may form part of the main solenoid valve 422 or be a separate component.

A capacitive sensor 430 is in electrical communication with the controller 34 and the faucet 13. More particularly, a portion of the faucet 13, illustratively a hub 432, defines an electrode in electrical communication with the capacitive sensor 430. The electrode 432 illustratively defines a user interface for providing input to the controller 34 and hence, operation of the electrically operable valves 422 and 424. Illustratively, a connector 434 (e.g., an electrical cable, such as an RJ45 cable) electrically couples the main solenoid valve 422 and the filter solenoid valve 424 via the controller 34. A fluid coupler 436, such as a T-connection, fluidly couples the main solenoid valve 422 and the filter solenoid valve 424.

The controller 34 illustratively defines a first or normal tap water mode and a second or filtered water mode. In the first mode, the main electrically operable valve 422 is open and the filter electrically operable valve 424 is closed. In the second mode, the main electrically operable valve 422 is closed and the filter electrically operable valve 424 is open. The controller 34 may toggle between the first mode and the second mode in response to user input to the capacitive sensor 430 via the electrode 432 (e.g., faucet hub). For example, a single touch by a user (e.g., a tap) on the faucet hub 432 causes the controller 34 to enter the first mode where normal tap water flows, and a double touch by the user (e.g., double tap) on the faucet hub 432 causes the controller 34 to enter the second mode where filtered water flows.

With reference now to FIG. 17, another illustrative embodiment water filtration system 450 includes a motorized linear diverter valve 452. The linear diverter valve 452 may include features similar to the type further detailed in PCT International Patent Application Publication No. WO 2023/043905 to Wales et al., the disclosure of which is expressly incorporated herein by reference. A benefit of the electronic water diverter device of the present invention over a mechanical filter switch is that it is not dependent on the function or pressure drop of the filter to drive the mechanism, which should make it universal.

The motorized linear diverter valve 452 illustratively includes a shuttle 454 configured to receive water (indicated by arrow 453 in FIG. 17) and as it translates, the water from an inlet 455 fluidly connects successively to each of different outlets 456, 458, 460, 462 and 464. Illustratively, five outlets are shown, but the linear diverter valve 452 could include any number of outlets. Additionally, the diverter valve 452 could include multiple simultaneous outlets, i.e. water could flow from any combination of the outlets 456, 458, 460, 462 and 464.

For all of the illustrative embodiments of FIGS. 1-17, an optional high flow rate carbon filter (not shown) could be implemented within the unfiltered cold water path 25. This filter could be implemented if the user wished to have basic filtration effective on cold water at all times. The filtration system 26 is of higher quality and could then only be used for things such as drinking, cooking, and cleaning (as in the case of a reverse osmosis (RO) system).

In an illustrative embodiment, a reverse osmosis (RO) system may cooperate with metered dispense to facilitate voice controlled metered dispense with line purging. A sequence, such as turning on the manual faucet valve 24 and telling a voice recognition device 58, 80 (e.g., Alexa) to dispense a certain volume of filtered water. For example, a user could ask the voice recognition device 58, 80 to dispense one gallon of purified water would result in the water diverter device 52, 72 activating, allowing the water to run for a few seconds, and then shutting off the water with a filter switcher wireless button blinking, wherein depressing the button would activate the dispensing of filtered water.

In any of the illustrative integrated embodiment systems 50, 70, 100, 220 (e.g, FIGS. 2-4 and 7), when water flow from the water outlet 46 is stopped, the respective filtration system 26 may be reset to normal water flow via flow path 25. Alternatively, this could also be configurable, either to not reset or to reset after a certain period of time has elapsed). For the illustrative stand-alone embodiment system 10 (e.g., FIG. 1), an inexpensive flow meter 116 or flow switch may be used to identify when water flow stops and reset the water diverter device 12. If a flow meter 116 is used, it could also be used with a programmable filter life tracker. If only a flow switch is used, this could be calibrated with the filter flow rate and facilitate an approximate usage tracker.

For all of the illustrative embodiment water filtration systems 10, 50, 70, 100, 220 of FIGS. 1-17, the means for user input (e.g., user interface 42, 284, 432) to control the respective system (for example, a button, a switch, a dial or a touch screen), can be in wired or wireless communication with the controller 34. Illustratively, the system 10, 50, 70, 100, 220 may include a single button, or multiple buttons (e.g., a first button to activate a filtered mode, and a second button to activate an unfiltered mode). In an illustrative embodiment, the button is in communication with the controller through a one-way, low cost radio frequency (RF) link. In another illustrative embodiment, Bluetooth or Wi-Fi is utilized. In an illustrative embodiment, this functionality is integrated with a voice recognition module and/or a touch control module, which would then allow flow-based filter life tracking by communication with a smart filter or user input. In another illustrative embodiment, user input could be automated with QR codes or radio frequency identification (RFID) on filters scanned by smart phone through a mobile application (e.g., smart phone application).

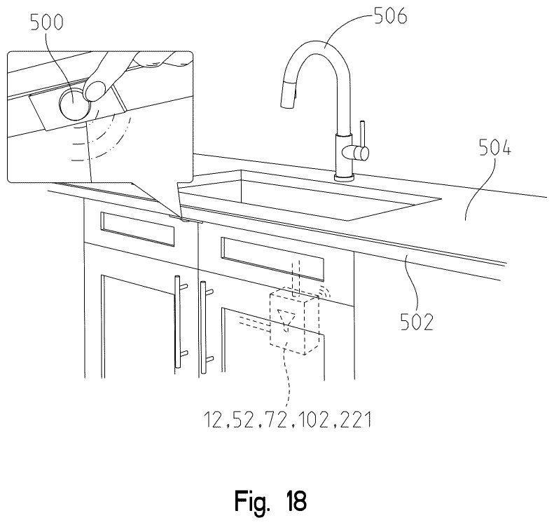

FIGS. 18-25 show additional illustrative wireless configurations and means for user input to activate the water diverter device 12, 52, 72, 102, 221 of the system 10, 50, 70, 100, 220, respectively.

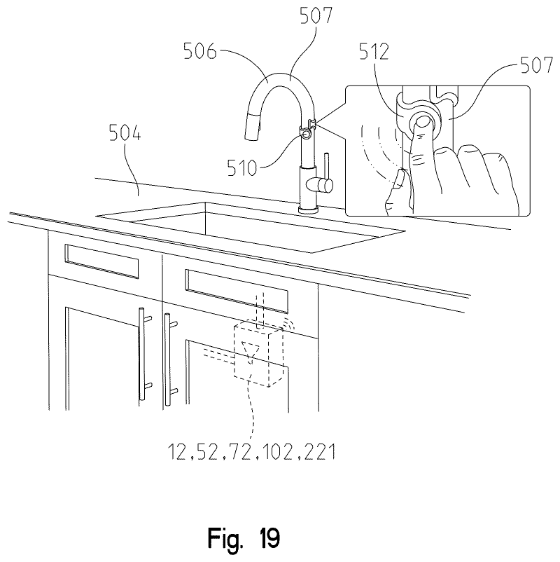

With reference to FIG. 18, an illustrative user input may include a button 500 mounted discreetly under the ledge 502 of a countertop 504 where the faucet 506 is mounted. The button 300 is in wireless communication with the water diverter device 12, 52, 72, 102 and 221. When a user depresses the button 500, a wireless transmitter on the button 500 sends a signal to the controller 34 to toggle between filtered and unfiltered water output. FIG. 19 shows a similar button 510 mounted with a flexible strap 512 on the body (e.g., delivery spout 507) of the faucet 506.

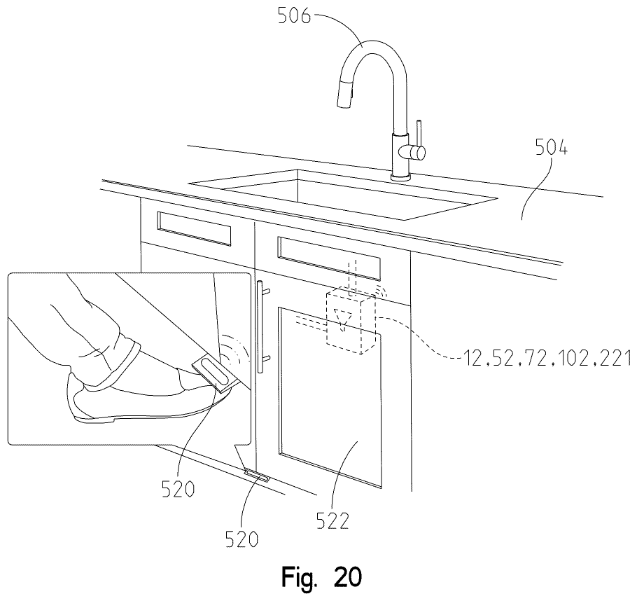

With reference to FIG. 20, a further illustrative user input may include a toe pedal 520 mounted behind cabinet doors 522 located below countertop 504. The pedal 520 is in wireless communication with the diverter device 12, 52, 72, 102 and 221. When a user's foot gently lifts the pedal upward, a transmitter on the pedal 520 sends a signal to the controller 34 to toggle between filtered and unfiltered water output. In an illustrative embodiment, pedal 520 may include indicator lights that allow a user to visually identify when the system is filtering water.

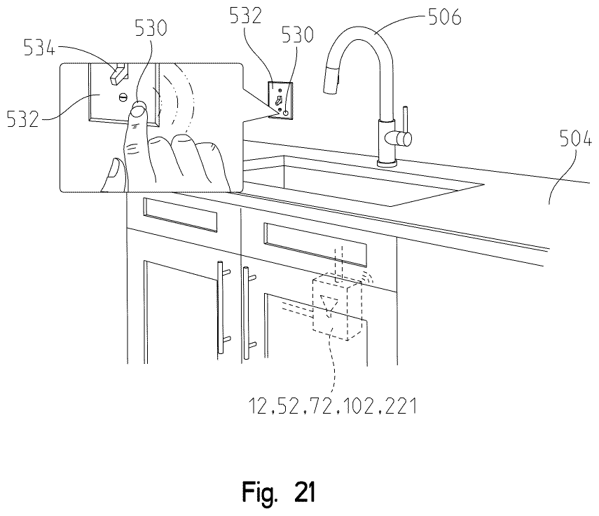

With reference to FIG. 21, another illustrative user input may include a button 530 that functions similarly to button 500 described above. However, button 530 is mounted on a light switch plate 532 including a toggle switch 534. The light switch plate 532 is mounted on a wall and can replace a standard switch plate a user might already have installed.

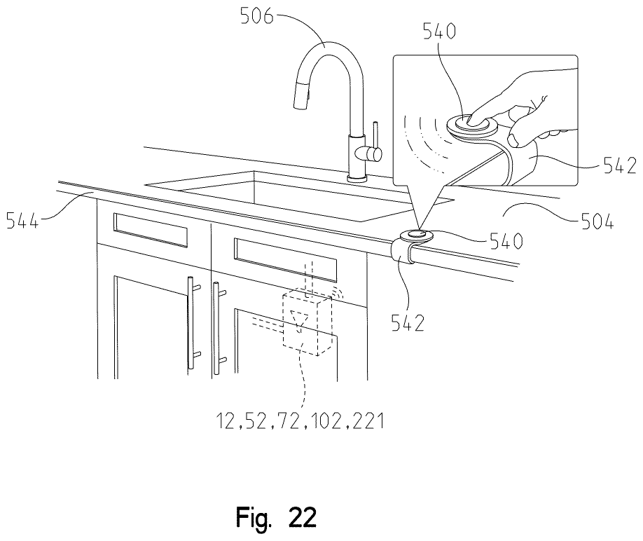

With reference to FIG. 22, another illustrative user input may include a button 540 that functions similarly to button 500 described above. Button 540 is also mounted with a flexible strap 542. Illustratively, the flexible strap 542 is shown clipped on to the edge 544 of countertop 504. In other embodiments, the flexible strap 542 may be mounted to other objects surrounding the countertop 504 or faucet 506 allowing flexible placement based on user preferences.

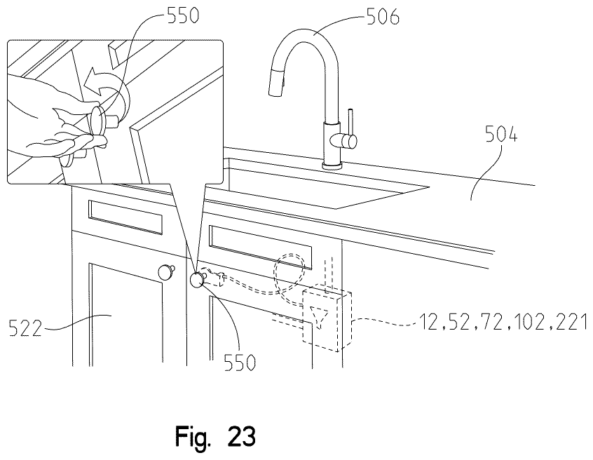

With reference to FIG. 23, a further illustrative user input may include a knob 550 on the cabinet door 522 used to activate the water filtration system 10, 50, 70, 100, 220. A user illustratively turns or pushes the knob 350 to toggle between filtered and unfiltered water. This configuration allows for the utilization of an existing knob 350 by attaching the water diverter device 12, 52, 72, 102 and 221 behind the cabinet 522. This illustrative configuration could be wired (as shown) or wireless.

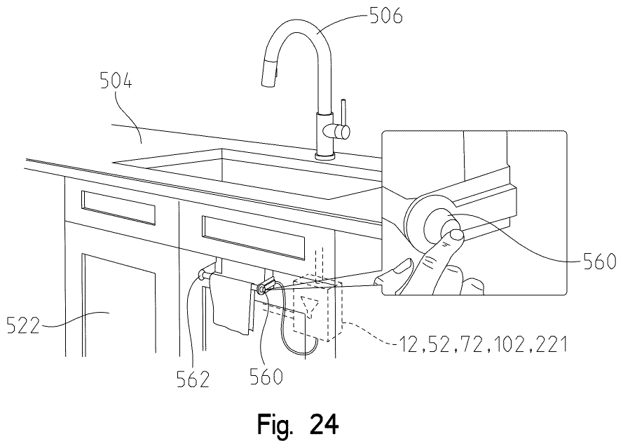

With reference to FIG. 24, another illustrative user input includes a button 560 which functions similarly to button 500 described above. However, button 560 is mounted on the end of a towel bar 562 placed on the outside of the cabinet door 522. This illustrative configuration could be wired (as shown) or wireless.

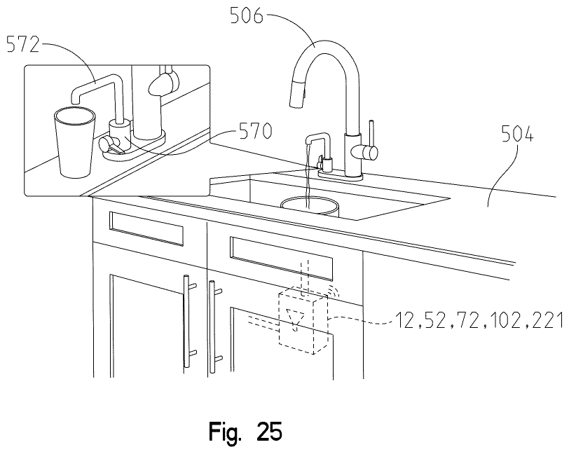

With reference to FIG. 25, a separate filter water faucet 570 is shown supported by the countertop 504. Illustratively, the filter water faucet 370 is shown on counter 304 next to conventional faucet 306. In other embodiments, filter water faucet 370 may be conveniently located in other places on countertop 504. To toggle between filtered and unfiltered water output, a user may illustratively rotate the delivery spout 572 of the filter water faucet 570.

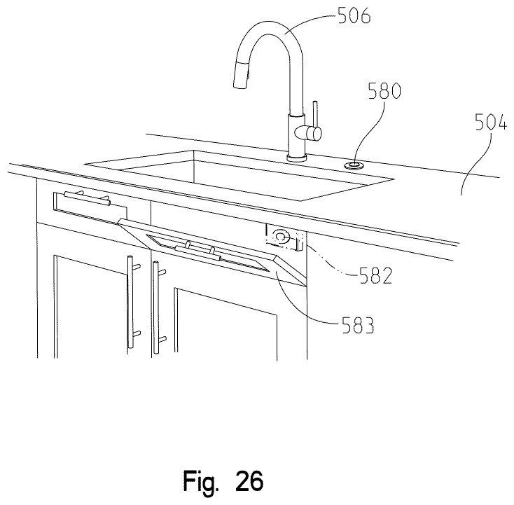

FIGS. 26-28 show various illustrative wired configurations and means for user input to activate the water diverter device 12, 52, 72, 102, 221 of the system 10, 50, 70, 100, 220 respectively. From an interface perspective, a wired link is thinner, more flexible, easier to hide, and has more options for implementation than a cable actuator in a mechanical system.

With reference to FIG. 26, an illustrative user input may include a button 580 installed in a hole on the countertop 504. This may be particularly convenient for users that have pre-existing openings in the countertop 504. This option is more discrete than an additional faucet. In certain illustrative installations, a small hole could be drilled in the sink flange (or elsewhere in the countertop 504 around the sink) as is often the case with switch buttons used frequently for garbage disposals.

A button 582 could also be placed just inside a cabinet door 583 to be completely discrete but not out of reach, as shown in FIG. 26. Also, a button 582 could be drilled through the false drawer face at the front of the cabinet and/or a button assembly may be used to replace the drawer faces (which are removable) thus not harming the cabinetry. The button 582 could also be installed in or behind a pivoting assembly. This is popular with pivot mechanism sold to make false drawers actually usable.

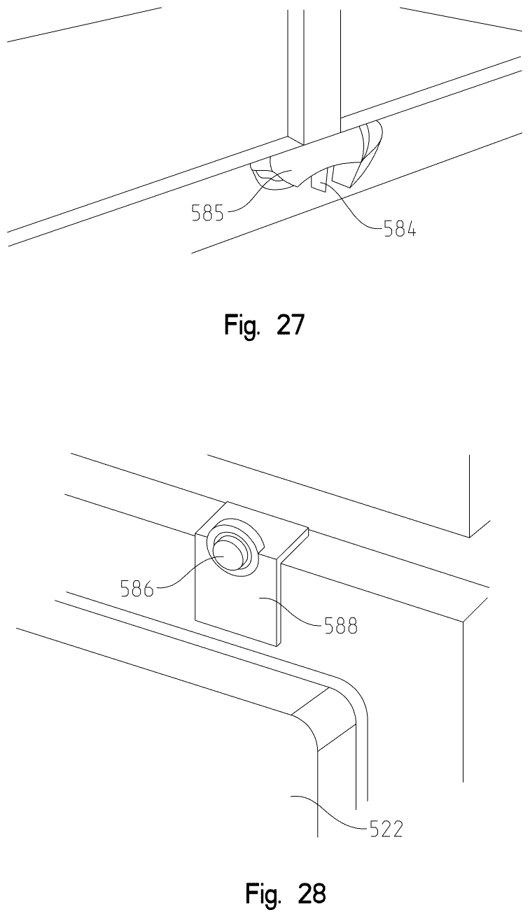

A button 584 could also be mounted in the toe kick 585 as shown in FIG. 27. FIG. 28 shows that the button 586 could also be mounted in a hanger 588 that hangs on the cabinet door 522, for a fast installation with no modifications at all.

For illustrative embodiments where the water filter device 72, 421 is integrated with capacitive sensing (e.g., touch), user input on the faucet hub 432 and a corresponding special light color (or pattern) in an indicator light on the faucet 13 could be utilized. The ability to control the water filter device 72, 421 without an additional clutter, button, hole, or modification is considered a major advantage.

Additionally, Wi-Fi, voice, and smart application integration are additional options as well for the user input. The option would then be to use voice for filter activation and have no button to reduce clutter.

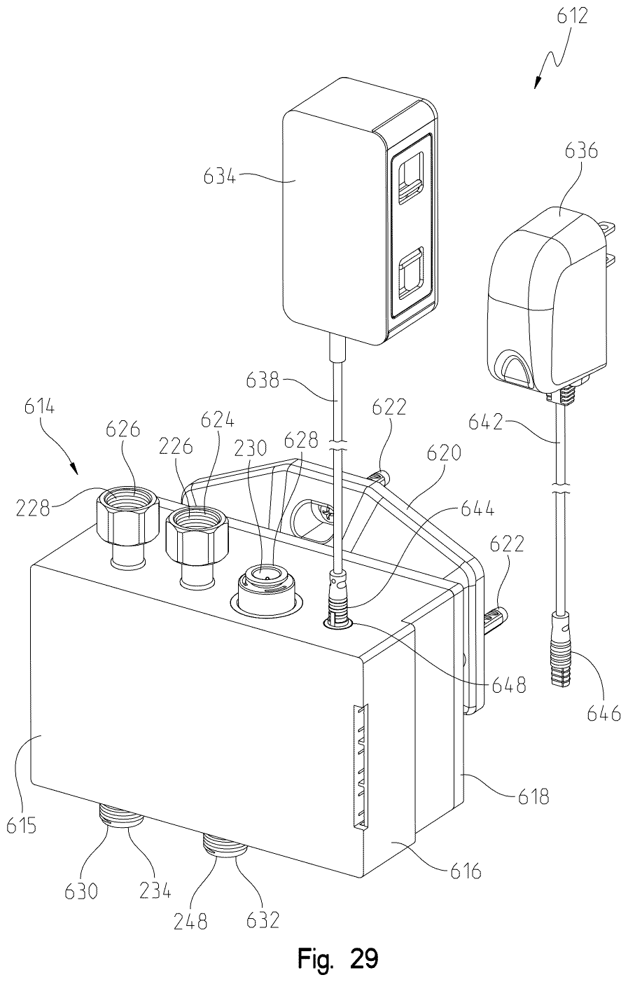

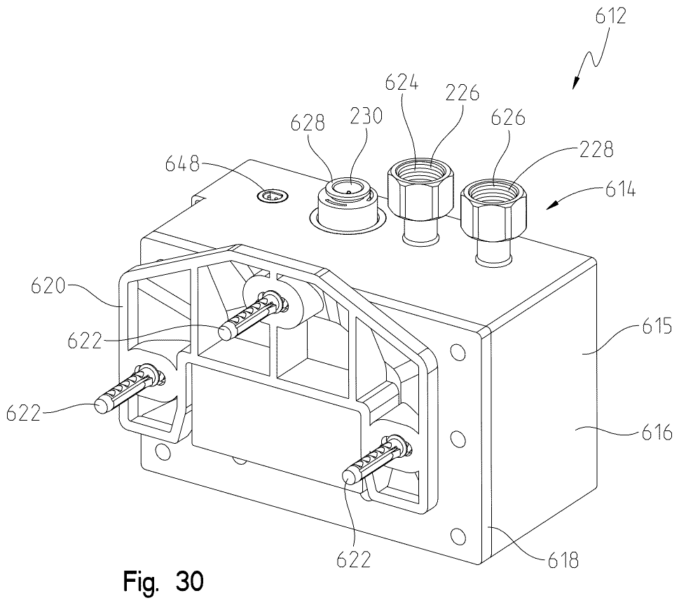

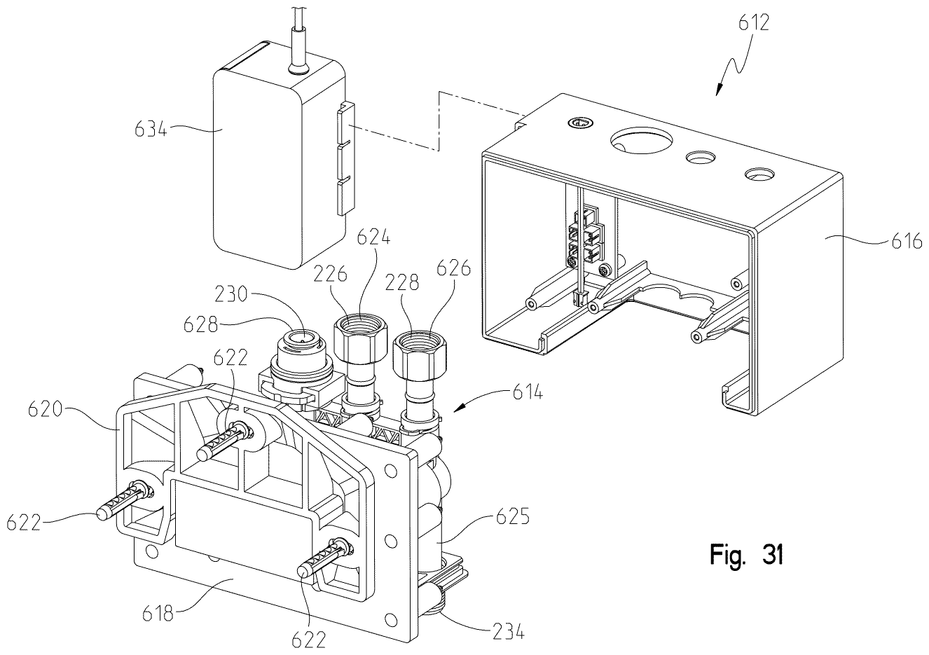

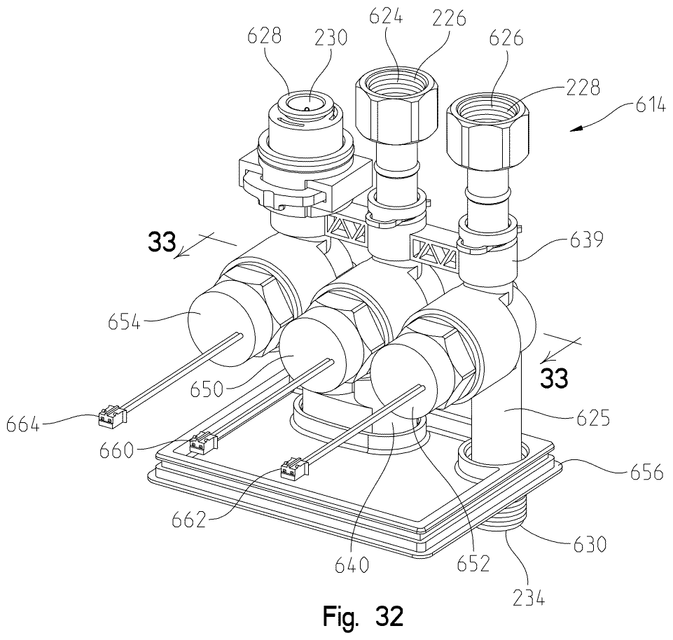

FIGS. 29-33 show additional illustrative implementation details of the illustrative water filtration system 10 of FIG. 1. More particularly, an illustrative water diverter device 612 includes many similar features as the water diverter device 12 detailed above. As such, in the following description, similar components are identified with like reference numbers.

The illustrative water diverter device 612 includes a flow module 614 received within a housing 615 defined by a cover 616 and rear wall 618. A mounting bracket 620 may be coupled to the rear wall 618 for supporting the water diverter device 612 on a wall (for example, below a countertop) via a conventional fastener such as bolts 622.

The illustrative flow module 614 includes a valve body 625 similar to the valve body 225 detailed above. The valve body 625 illustratively includes an unfiltered cold water inlet 226 in fluid communication with the unfiltered cold water path 25, a hot water inlet 228 in fluid communication with the unfiltered hot water path 33, a filter water inlet 230 in fluid communication with the filtered cold water path 27, and a filter water outlet 232 in fluid communication with a mixing valve 24 of a faucet 13. The valve body 625 further illustratively includes an unfiltered cold water outlet 233 in fluid communication with the faucet mixing valve 24, and a hot water outlet 234 in fluid communication with the faucet mixing valve 24. The outlets 232 and 233 are fluidly coupled to a combined water outlet 248.

Conventional fluid couplers, such as internally threaded nuts 624 and 626, are illustratively coupled to the inlets 226 and 228, respectively. A quick connect fluid coupler, such as a push-to-connect fitting 628, is illustratively coupled to the filter water inlet 230. Conventional fluid couplers, such as external threads 630 and 632, are illustratively coupled to the outlets 234 and 248, respectively.

A power supply 43 is in electrical communication with the controller 34. The power supply 43 may be of conventional design, such as a battery pack 634 or an AC-to-DC converter 636. The battery pack 634 illustratively includes a wire 638 and a plug 644, while the AC-to-DC converter 636 includes a wire 642 and a plug 646. Both plugs 644 and 646 may be interchangeably coupled to a receiving port 648 supported by the housing 615 and electrically coupled to the controller 34.

The module 614 also includes a cold water electrically operable valve 650, a hot water electrically operable valve 652 and a filter water electrically operable valve 654. The electrically operable valves 650, 652 and 654 may be similar to the solenoid valves 14, 16 and 18, detailed above. The module 614 is illustratively supported by a base 656 received within the housing 615. Each of the illustrative solenoid valves 650, 652 and 654 includes a control wire 660, 662 and 664, respectively, for coupling to the controller 34.

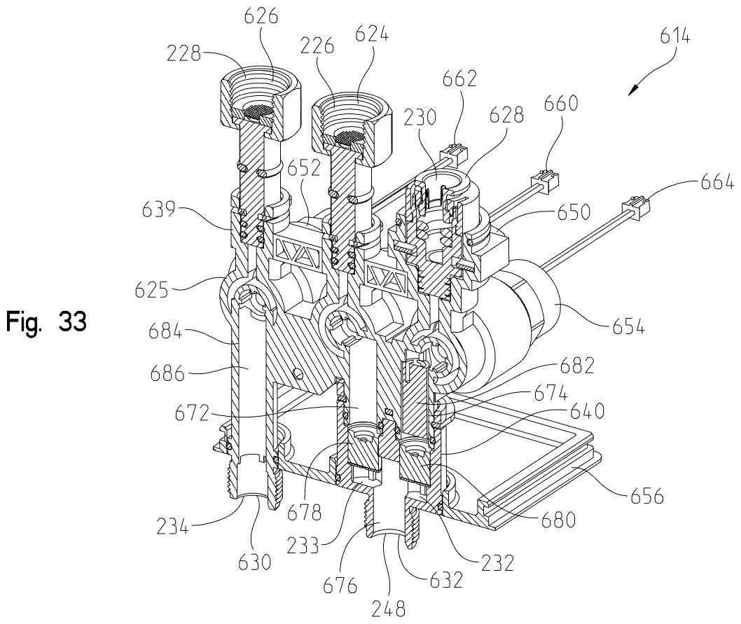

With reference to FIG. 33, the valve body 625 includes a main body portion 639 coupled to a connector portion 640. The connector portion 640 includes a first flow passageway 672 and a second flow passageway 674 coupled to an outlet flow passageway 676. Check valves 678 and 680 are illustratively received within the flow passageways 672 and 674, respectively. A flow switch 682 may also be received within the flow passageway 674. The flow switch 682 is in electrical communication with the controller 34 and detects if water is not flowing through the flow passageway 674. When filtered water stops flowing, the controller 34 switches the device 612 back to the tap water mode of operation.

Although the invention has been described in detail with reference to certain preferred embodiments, variations and modifications exist within the spirit and scope of the invention as described and defined in the following claims.

1. A water diverter device comprising:
an electrically operable valve assembly in fluid communication with a cold water source and a hot water source;
a control module electrically coupled to the electrically operable valve assembly;
a filtration system in fluid communication with the electrically operable valve assembly;
a user interface operably coupled to the control module;
an unfiltered cold water path defined by the electrically operable valve assembly from the cold water source to a water outlet;
a filtered cold water path defined by the electrically operable valve assembly from the cold water source to the water outlet via the filtration system;
an unfiltered hot water path defined by the electrically operable valve assembly from the hot water source to the water outlet;
wherein, a normal position of the valve assembly allows cold water and hot water to flow to the water outlet via the unfiltered cold water path and the unfiltered hot water path; and
wherein, the control module utilizes input from the user interface to change the position of the valve assembly to a filtered position to stop the flow of cold water and hot water via the unfiltered cold water path and the unfiltered hot water path, and allow filtered cold water to flow to the water outlet via the filtered cold water path.

2. The water diverter device of claim 1, wherein the electrically operable valve assembly includes:
an unfiltered cold water valve in fluid communication with the cold water source to define the unfiltered cold water path, and in a normally open position;
a filtered cold water valve in fluid communication with the cold water source to define the filtered cold water path, and in a normally closed position; and
an unfiltered hot water valve in fluid communication with the hot water source to define the unfiltered hot water path, and in a normally open position.

3. The water diverter device of claim 2, wherein each of the unfiltered cold water valve, the filtered cold water valve, and the unfiltered hot water valve comprise a solenoid valve.

4. The water diverter device of claim 2, further comprising a supplemental cold water valve in fluid communication with the cold water source in parallel with the unfiltered cold water valve and the filtered cold water valve.

5. The water diverter device of claim 4, further comprising an ozone system fluidly coupled to the supplemental cold water valve.

6. The water diverter device of claim 2, further comprising a remineralizer fluidly coupled downstream from the filtration system.

7. The water diverter device of claim 1, wherein the electrically operable valve assembly includes a rotary diverter valve.

8. The water diverter device of claim 1, wherein the electrically operable valve assembly includes a linear diverter valve.

9. The water diverter device of claim 1, further comprising an ultraviolet module positioned downstream of the electrically operable valve assembly.

10. The water diverter device of claim 1, wherein the control module includes a capacitive sensing module.

11. The water diverter device of claim 1, wherein the control module includes a voice recognition module.

12. The water diverter device of claim 1, wherein the user interface includes a wireless transmitter in communication with the control module.

13. The water diverter device of claim 12, wherein the user interface includes a housing supporting a push button operably coupled to the wireless transmitter.

14. The water diverter device of claim 1, further comprising a mixing valve positioned intermediate the electrically operable valve assembly and the water outlet.

15. The water diverter device of claim 1, wherein the filtration system includes a water filter, and the control module is configured to track life of the water filter.

16. The water diverter device of claim 15, further comprising a flow meter operably coupled to the control module and configured to detect the flow of water passing through the water filter, the control module configured to track life of the water filter based upon input from the flow meter.

17. A water diverter device comprising:
an electrically operable valve assembly including a cold water inlet in fluid communication with a cold water source, a hot water inlet in fluid communication with a hot water source, and a filtered water inlet;
a filtration system in fluid communication with the filtered water inlet of the electrically operable valve assembly; and
wherein the electrically operable valve assembly includes a first mode and a second mode, the cold water inlet and the hot water inlet in fluid communication with a water outlet in the first mode, and the filtered water inlet in fluid communication with the water outlet in the second mode.

18. The water diverter device of claim 17, wherein the electrically operable valve assembly includes:
an unfiltered cold water valve in fluid communication with a cold water inlet to define the unfiltered cold water path, and in a normally open position;
a filtered cold water valve in fluid communication with a cold water inlet to define the filtered cold water path, and in a normally closed position; and
an unfiltered hot water valve in fluid communication with a hot water inlet to define the unfiltered hot water path, and in a normally open position.

19. The water diverter device of claim 18, wherein each of the unfiltered cold water valve, the filtered cold water valve, and the unfiltered hot water valve comprise a solenoid valve.

20. The water diverter device of claim 17, wherein the electrically operable valve assembly includes a rotary diverter valve.

21. The water diverter device of claim 17, wherein the electrically operable valve assembly includes a linear diverter valve.

22. The water diverter device of claim 17, further comprising an ultraviolet module positioned downstream of the electrically operable valve assembly.

23. The water diverter device of claim 17, further comprising a control module in electrical communication with the electrically operable valve assembly.

24. The water diverter device of claim 23, wherein the control module includes a capacitive sensing module.

25. The water diverter device of claim 23, wherein the control module includes a voice recognition module.

26. The water diverter device of claim 23, further comprising a user interface including a wireless transmitter in communication with the control module.

27. The water diverter device of claim 26, wherein the user interface includes a housing supporting a push button operably coupled to the wireless transmitter.

28. The water diverter device of claim 17, further comprising a mixing valve positioned intermediate the electrically operable valve assembly and the water outlet.

29. A water diverter device comprising:
a main electrically operable valve including an inlet and an outlet;
a filter electrically operable valve including an inlet and an outlet, the outlet of the filter electrically operable valve fluidly coupled to the inlet of the main electrically operable valve;
a filtration system including an inlet and an outlet, the inlet of the filtration system fluidly coupled to a cold water source, and the outlet of filtration system fluidly coupled to the inlet of the filter electrically operable valve;
a controller operably coupled to the main electrically operable valve and the filter electrically operable valve;
a capacitive sensor operably coupled to the controller; and
wherein the controller defines a first mode and a second mode, the main electrically operable valve open and the filter electrically operable valve closed in the first mode, and the main electrically operable valve closed and the filter electrically operable valve open in the second mode.

30. The water diverter device of claim 29, further comprising an electrode operably coupled to the controller for receiving input from a user.

31. The water diverter device of claim 30, wherein the electrode is defined by a faucet component.

32. The water diverter device of claim 31, wherein the faucet component comprises a faucet hub supporting a delivery spout.

33. The water diverter device of claim 30, wherein a single touch on the faucet component causes the controller to operate in the first mode, and a double touch on the faucet component causes the controller to operate in the second mode.

34. The water diverter device of claim 29, wherein each of the main electrically operable valve and filter electrically operable valve comprise a solenoid valve.

35. The water diverter device of claim 29, further comprising a faucet defining a water outlet, and a mixing valve positioned intermediate the main electrically operable valve and the water outlet.
